(19) United States
(12) Patent Application Publication
(10) Pub. No.: US 2016/0371936 A1
(43) Pub. Date: Dec. 22, 2016

(54) Blackjack Game with Alternate Side Bets and Related Themes

(71) Applicant: Patrick Mendicino, Sewickley, PA (US)

(72) Inventor: Patrick Mendicino, Sewickley, PA (US)

(21) Appl. No.: 15/252,552

(22) Filed: Aug. 31, 2016

Related U.S. Application Data
(63) Continuation-in-part of application No. 14/710,673, filed on May 13, 2015, now abandoned.
Application No. 14/710,673 is a continuation-in-part of application No. 13/900,900, filed on May 23, 2013, now abandoned.
(60) Provisional application No. 61/650,517, filed on May 23, 2012.

(51) Int. Cl. G07F 17/32; A63F 1/00

(52) U.S. Cl. CPC G07F 17/3293; A63F 1/00; G07F 17/3211; G07F 17/3276; G07F 17/3248; G07F 17/3225; G07F 17/322; A63F 2001/003

(57) ABSTRACT

A method and system to play a Blackjack variation between a player and a dealer for a casino that involves a new and original decks of cards in which all Jacks and Queens are removed and new Kings cards are substituted, a game table with side bet areas, a designated coin for placing a side bet, and an optional side wager option bonus scheme based on three-of-a-kind and four-of-a-kind combinations resulting from comparison of a player's initial two dealt cards, the dealer's up card, and the dealer's down card. The bonus scheme can provide for varying pay-outs based on any three-of-a-kind combination, combinations in the same card colors, and combinations in the same card suit. The bonus scheme and associated numbers for which a pay-out is made can be tied to a theme or themes. The method and system uses a specialized game board and a designated coin for making the side bets.

### CROSS REFERENCE TO RELATED APPLICATIONS

This application is a Continuation In Part Application of Continuation In Part Application Ser. No. 14/710,673 entitled “Blackjack Game with Alternate Side Bets and Related Themes” filed on May 23, 2015, claiming priority of U.S. Non-Provisional Application Ser. No. 13/900,900 entitled “Blackjack Game with Alternate Side Bets and Related Themes” filed on May 23, 2013, claiming priority of U.S. Provisional Application Ser. No. 61/650,517 filed on May 23, 2012, which are all incorporated herein by reference in their entirety.

### FIELD OF THE INVENTION

The invention pertains to the field of Blackjack games. More particularly, the invention pertains to a Blackjack game using a new and original deck of cards with alternate side bets and related themes.

### BACKGROUND OF THE INVENTION

In the field of gaming many different card games have been developed for use in both casual and gambling settings. One of the most common games is Blackjack or 21. The basic game of Blackjack is well-known in the art. The end goal of the game is for a player to achieve, through their cards, a total value of 21 or less, but more than the value of the dealer's cards. A “Blackjack” occurs when the two original cards, either the player's or the dealer's, combine to 21. This is achieved through having an Ace (with an associated value of 1 or 11), and a ten value card (either a 10 or a face card).

In casinos, it has been recognized that additional interest in Blackjack, with an associated increase in bets, can be obtained through the use of side games or side bets along with the standard game of Blackjack. For example, U.S. Pat. No. 6,896,266 discloses a side game for Blackjack wherein the player places a side wager that the dealer's up card will be a ten. Further additional payouts are disclosed based upon the value of the dealer's down card.

While a variety of different card games and Blackjack side bet games have been developed, a need exists for theme-based side bets which attract players not only for the potential winnings associated with the side bets, but also for the “fun” and enjoyment of playing the side bets. Adding a new or original deck of cards to such a game enhances the fun and attraction of such a game.

### SUMMARY OF THE INVENTION

The present invention provides a method and system to play a Blackjack variation between a player and a dealer for a casino that involves an optional side wager option bonus scheme based on three-of-a-kind and four-of-a-kind combinations resulting from comparison of a player's initial two dealt cards, the dealer's up card, and the dealer's down card, which is turned up at the end of a round, even if all players have “busted.” This latter consideration of the dealer's down card is not common in all casinos. The bonus scheme can provide for varying pay-outs based on any three-of-a-kind or four-of-a-kind combination, combinations in the same card colors, and combinations in the same card suit. (The latter is dependent upon the number of decks in use). The bonus scheme and associated numbers for which a pay-out is made can be tied to a theme or themes. The present invention is used in connection with a special game board and a special coin or token that is used to place the side bet.

The method and system of the present invention also uses a new and original deck of cards. In particular, a standard deck of cards is used, but all Jacks and Queens are removed, and additional Kings cards, in corresponding suits, are substituted.

### BRIEF DESCRIPTION OF THE DRAWINGS

FIG. 1 is a simplified flow diagram describing the method steps of this invention according to one contemplated embodiment.

FIG. 2 shows a top view of a table layout associated with one embodiment of the Blackjack game and side bets of the present invention.

FIG. 3 is an exemplary block diagram of hardware that can be used to implement an electronic embodiment of the present invention.

### DESCRIPTION OF PREFERRED EMBODIMENTS

This invention provides a novel side bet or side wager to a regular or traditional game of Blackjack. The invention, as a system and method of play, can be played as a real-life table game with physical cards, or via electronic representations thereof through a computer, gaming terminal, the Internet, or the like. In the electronic implementations, the system and method can include a non-transitory computer readable medium code with instructions and executed by a processor to perform the steps of this invention as described in this description and the related figures.

Blackjack is typically played with one or more standard decks of 52 cards. Cards 2 through 10 are worth their face value and face cards (Jack, Queen and King) are also worth ten. An ace's value may be either eleven or one. A hand in which the ace's value is counted as eleven is called a soft hand, because the hand cannot be busted if the player draws another card. A hand in which the ace's value is counted as one is called a hard hand. In the present invention, a new and original deck of cards is used. In particular, the system and method of the present invention uses a deck of cards in which all Jack and Queen cards are removed and King cards in corresponding suits are substituted therefore. In alternative embodiments, no King cards are substituted for, or the substituted King cards are less than, the removed cards. The odds of obtaining three-of-kind or four-of-a-kind matches on King cards are impacted by the total number of King cards in a particular deck. Also, if King cards are substituted one-for-one in connection with removal of Jack and Queen cards, the odds of obtaining a “Blackjack” at a total value of 21 remains the same (as the total number of cards having a value of “10” remains the same).

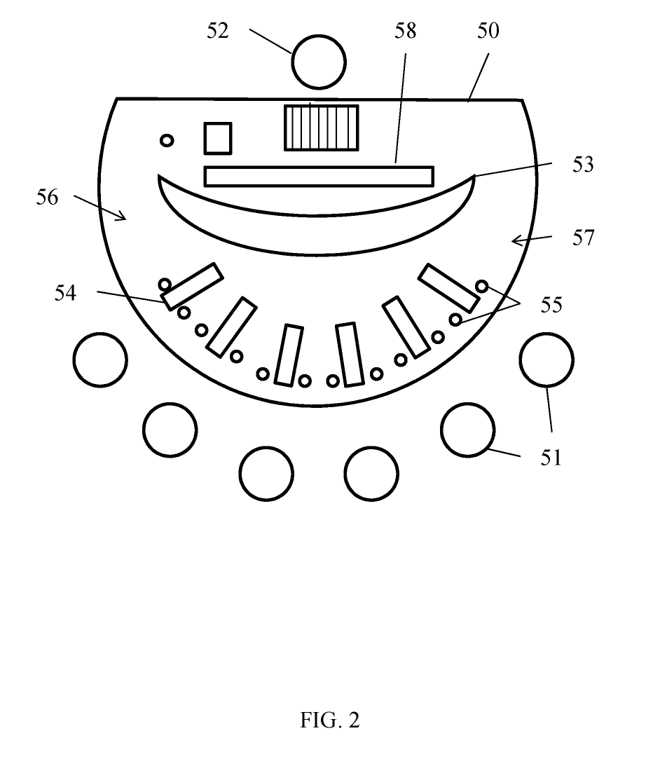

When multiple decks are used, there is usually an even number of decks (e.g., 2, 4, 6, 8) although some casinos use five or seven decks. The use of multiple decks permits the dealer to deal more hands per hour, thereby increasing the casino take, and it reduces (but does not eliminate) the player advantage gained from card counting. In multi-deck games, the cards are dealt out of a tray-like box called a shoe and some casinos use continuous shufflers. FIG. 2 shows a general lay-out of a real-life dealer table adapted for the present invention, with the first seat on the dealer's left conventionally referred to as First Base, and the first seat on the dealer's right referred to as Third Base. The same table can be represented through an electronic medium.

At the beginning of each round of Blackjack play, each player indicates his or her base bet by placing one or more chips, cheques, markers, or other wagering devices in the base betting spot. The amount of base bet which a player may make for a particular game or table may be regulated between certain maximum and minimum values by a casino or other authority. Also before any cards are dealt, each player may make an additional, side bet by placing one or more chips, markers, or other wagering devices in the auxiliary or side bet spots. In particular, in a preferred embodiment of the present invention, the side bets provide for a win or payoff if a player receives three or four of the same type of card, e.g., three or four twos or three sevens, through the player's first two cards, the dealer's “up” card, and the dealer's “down” card (turned over at the end of a game even if all players “bust” or go over twenty-one). In a further embodiment, the side bets can be limited to a certain card or cards relating to a theme. The amount of the side bet can vary and may be subject to casino guidelines. In a preferred embodiment, the side bet is made with a special coin or coins representing the amount of the bet. A corresponding symbol on the game table can be used to receive the coin or side bet when placed.

The placing of an additional bonus bet is optional, and a player may elect not to place an additional bonus bet in a particular game or round of play and still participate in that particular game or round of play provided the player has made a base bet. Again, in a preferred embodiment, the side bets are placed initially—before any cards are dealt. In this embodiment, if the first cards dealt, i.e., the players first two up cards and the dealers up card, are not the applicable combinations, e.g., three sixes or three sevens, then a side bet based on these first these three cards alone, if applicable, fails. On the other hand, if these first three cards match to create a three-of-a-kind, then a side bet pay-out may occur of the three-of-a-kind matches the bonus scheme. In addition, as an added bonus or extra side bet, the player may also win a pay-out if the dealer's down card, when turned over, creates a four-of-a-kind that matches to the bonus scheme. In another embodiment, the game may allow a side bet to played after a player has seen his or her first card; however, the odds on a possible win would change and the potential winnings would be lowered for such a side bet placed at this time.

In further variations on this invention, there are three ways to win each side bet as to a particular card, e.g., three or four of the same type of card. The first way to win is to have three or four of the desired card—e.g., three or four Kings, sixes or aces—in any suits. A focus on Kings would improve odds based on the total number of Kings cards in the new and original card deck. The second way to win—with a higher payout—is to have three or four of the same card in the same color suit. The third way to win—with an even higher payout—is to have three or four of the same card in the same suit. The amounts of the three types of possible payouts will be determined by casino operators, based on associated odds. These odds are, in turn, based on applicable factors, including the numbers of decks used for a particular game.

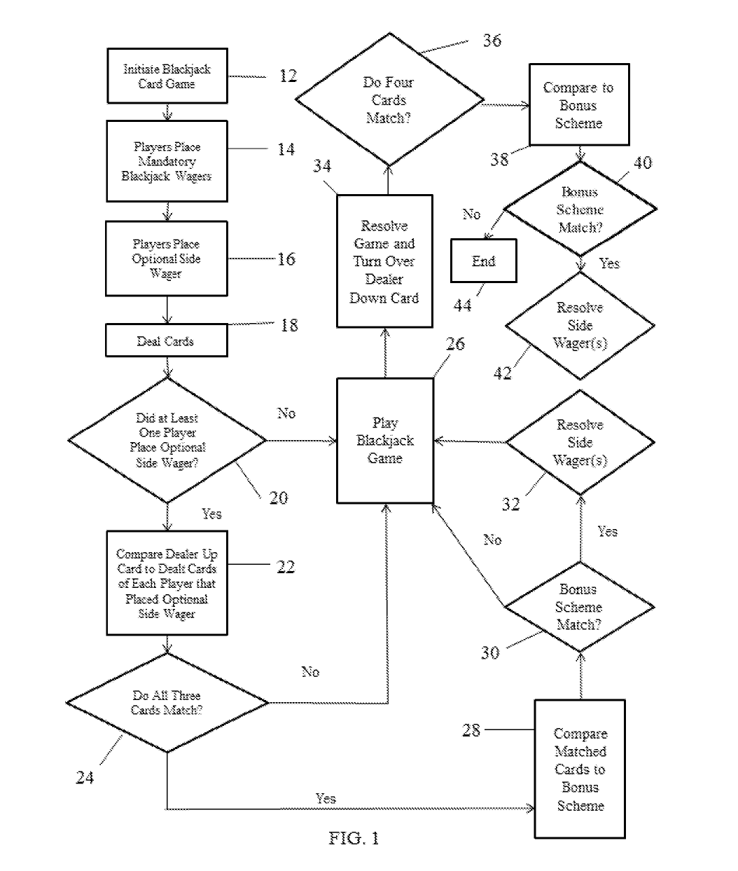

Referring to FIG. 1, the process steps associated with one embodiment of the system and method of the present are shown in an exemplary flowchart representation. As shown in the exemplary embodiment of FIG. 1, the process starts at operation 12, which involves the initiation of a Blackjack card game. For both real-life and electronic card games, this operation can involve (i) selection of the number of the new and original decks of cards (decks excluding Jacks and Queens) used for the game, (ii) setting of the mandatory wagers and associated pay-outs, (iii) setting the parameters for optional side wagers relating to the three-of-a-kind combination and associated odds and pay-outs, and (iv) identifying the number of players. In an electronic version of the game, initiation can also involve turning the game to an “on” position and/or resetting to a new game. For a game console, game initiation can further involve the insertion of a coin or token to start a new game play. In connection with setting the parameters for the side wagers, there is a need to determine which card or cards are available for a three-of-kind win and also whether variable pay-outs will apply based on whether any three-of-a-kind occurs and/or if higher pay-outs will occur if the match is in the same color or the same suit. Alternatively, pay-outs can be limited to three-of-a-kind combinations in the same color and/or the same suit.

Operation 14 corresponds to the traditional wagers that are placed at the start of a Blackjack game. One or more players can play the game, with each placing any mandatory wagers to start the game. Operation 16 involves the optional placing of side bets based on the parameters set in operation 12. For example, with a theme-based game, optional bets can only be placed for certain possible three-of-a-kind or four-of-a-kind combinations involving only a specific card type or types, such as sixes and/or aces, with players given the choice of betting on such card types. Again, other three-of-a-kind combinations can be implemented in operation 12, including the possibility of winning based on obtaining a three-of-a-kind from more than one card type. Operation 16 can also involve the use of a particular coin or coins (or tokens) to place the side bet. The coins or tokens can give preset values, such as $1, $5, $10, $20, $25 and/or $50. Other values can also apply.

The game next proceeds to operation 18, where cards are dealt. Operation 20 is a decision point. If no player places an optional side bet, the players proceed to play a regular game of Blackjack at operation 26, which might include “House” rules as to other available side bets. If an optional side bet was placed by at least one player in operation 16, the game proceeds to operation 18, where cards are dealt for the purpose of determining if an applicable three-of-kind is obtained. More specifically, when all bets have been placed, including any optional side, the dealer deals two cards, one at a time to each player following the rules of conventional Blackjack. Depending on the variant of Blackjack, the players' cards are dealt either face down or face up. The dealer receives one card face down and one card face-up.

After this initial dealing of cards, operation 22 involves a comparison of the dealer's up card to the two cards for each player that placed an optional side bet. This comparison takes place before the regular game of Blackjack is completed.

Operation 24 analyzes the results of the comparison in operation 22. If the three cards do not match, then the regular game proceeds at operation 30. If the three cards do match, that is, a three-of-a-kind results, then the match or the three-of-a-kind is compared, at operation 26 to the bonus scheme set in operation 12. If, for example, a certain theme is played, any matches or three-of-a-kind combinations for cards other than the theme card type or types will not trigger a pay-out under a bonus scheme. Therefore, in operation 28, such other matches would be resolved by no pay-outs on the side wagers, and the game would proceed to a regular game at operation 26. On the other hand, if a three-of-a-kind results and it matches to the bonus scheme, then operation 30 proceeds to operation 32, in which the player's side wager is resolved and a pay-out on the side wager is made. The game then proceeds to a regular game at operation 26.

In an alternative embodiment, a player can have the option, at operation 32 to accept the bonus scheme match based on the dealer's up card and receive a side wager pay-out, or to pass on or decline the pay-out in anticipation of a four-of-a-kind match based on the dealer's down card. In this embodiment, a pay-out is made only to those players that have matched the bonus scheme through the dealer's up card, and who accept the pay-out. Again, this scheme may involve variable pay-outs depending on whether the match involves any combination, the same color and/or same suit of cards. After the pay-out is made or passed in operation 32, the game proceeds to operation 26, where the regular game of Blackjack proceeds.

In connection with continued play in operation 26, if the dealer is dealt a natural Blackjack hand, a player will lose his or her base bet, but will not lose a side bet if already paid out. After the dealer and players have been dealt an initial hand of two cards, each player in turn starting with First Base elects to receive one or more additional cards (a “hit” or “hits”) or to take no additional cards (“stand”). A player may elect to take additional cards until he or she decides to stand or until the point total of the player's hand exceeds twenty-one, known as “busting.” The regular game of Blackjack as described above may be supplemented with a number of alternative betting procedures, including surrender, insurance, doubling down, and splitting pairs.

Once all players have either received the desired number of cards or busted, including the players who were dealt a natural Blackjack hand with the first two cards, the dealer then takes additional cards or stands. Under most Blackjack rules, a dealer is not permitted to receive additional cards if the dealer's existing hand has a total point value of seventeen or greater and a dealer is required to take an additional card if the dealer's existing hand has a point total of less than seventeen.

When all of the players and the dealer have either received a desired number of cards or busted, the outcome of the base game is determined. A player wins if either the dealer's point total exceeds twenty-one (i.e., the dealer busts) or if the player's point total exceeds the dealer's point total. Before the game is finally resolved, though, in operation 34, the dealer turns over his down card even if all players have busted, and, in operation 36, the down card is compared with each player's first two cards and the dealer's initial up card.

Specifically, operation 36 also involves comparison of the dealer's down card to any winning three-of-a-kind combinations resulting from the player's first two up cards and the dealer's first up card in operations 24, 28 and 30. If the four cards do match, that is, a four-of-a-kind combination results, then the match or the four-of-a-kind is compared, at operation 38 to the bonus scheme set in operation 12. If, for example, a certain theme is played, any matches or four-of-a-kind combinations for cards other than the theme card type or types will not trigger a pay-out under a bonus scheme in operation 40. Therefore, in operation 44, such other matches would be resolved by no pay-outs on the side wagers, and the game would be finalized with pay-outs on the base game and any other side bets. The base pay-outs, along with other side bets, can alternatively be resolved before any side bets are paid on an applicable four-of-a-kind combination. On the other hand, if a four-of-a-kind results and it matches to the bonus scheme, then operation 40 proceeds to operation 42, in which the player receives an applicable pay-out. This added pay-out is available as a bonus or extra pay-out based on the initial side bet

Again, in an alternative embodiment of the present invention, the operations at operation 36 concerning a four-of-a-kind combination may only come into play if a player “passes” and does not accept a pay-out on the initial three-of-a-kind combination at operation 30. In other embodiments of the invention, operation 18 may proceed directly to operation 26, such that the dealer's down card determines whether a winning three-of-kind or four-of-a-kind combination occurs. In this latter embodiment, no side wager would be resolved, alone, by comparison of the player's first two up cards with the dealer's up card. Finally, in yet another embodiment, the present invention may focus solely on a four-of-a kind combination of the player's first two up cards, the dealer's first up card, and the dealer's down card. In this latter embodiment, three-of-a-kind combinations do not trigger a potential pay-out.

As described above, the method of playing Blackjack with an alternate, theme-based side bets in accordance with the present invention presents a player with the opportunity for a significant payout. The game retains the basic nature of Blackjack, albeit with a new and original deck of cards, but without interfering with the rhythm of the game.

Referring to FIG. 2, a method and system of playing Blackjack (also called 21) with alternate side bets in accordance with the present invention is played using the new and original deck of cards described above and on a real or simulated playing surface 50. In the embodiment shown in FIG. 2, a real playing surface 50 is preferably covered with felt or other material that is secured to the top of a casino-style table with a straight edge behind which a dealer stands facing the players and a semi-circular edge around which one or more players 51 sit or stand facing the dealer 52. Player 51a, to the right of the dealer, is referred to as the 3^{rd} base player. Player 51b, to the left of the dealer, is referred to as the 1st base player.

The covering on the playing surface 50 is preferably imprinted with various indicia including text describing basic house rules of play, e.g., dealer must hit a soft 17. With continuing reference to FIG. 2, playing surface 50 includes marked areas preprinted on the felt. The playing surface typically includes an arcuate portion 53 which separates the dealer's cards and playing portion from the player's playing portion. In one non-limiting embodiment, arcuate portion 53 is referred to as “the insurance line” and allows a “side bet” to occur during a round of Blackjack.

The playing surface 50 may have any desired shape and size and that nothing in this description is meant to limit the playing surface to any particular size and shape; the playing surface 50 may be formed in the top of a table or other such object. In other embodiments, the playing surface 50 can be simulated on a video screen and the game can be played via a computer under software control with the cards being simulated and the players participating via an interactive video station.

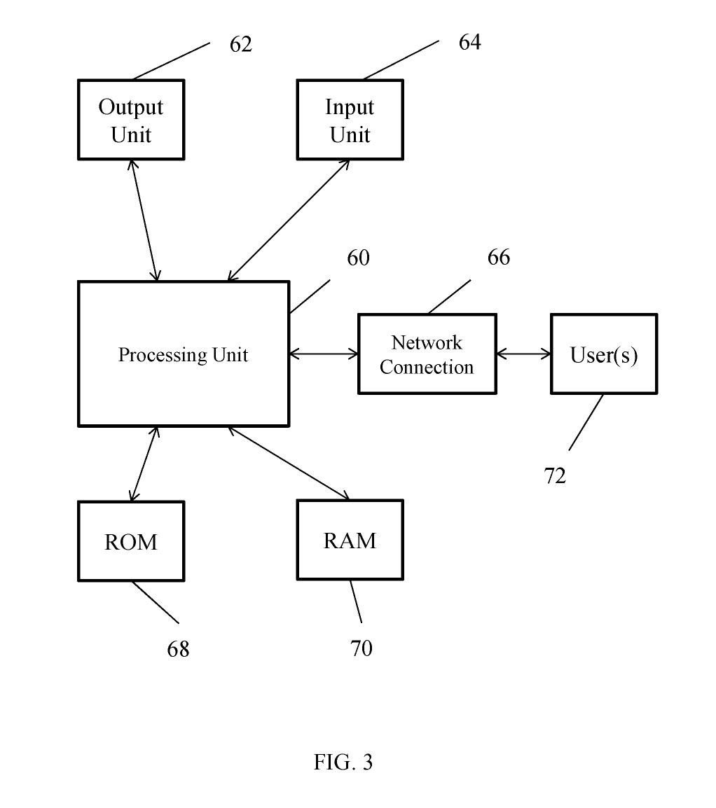

In the player's playing portion of the playing surface there are multiple locations for players 51, six of which are shown in FIG. 2. The number of these player locations can vary. Printed on playing surface 10 in front of each player location are betting spots or bonus pay tables 54 for placing a base bet in Blackjack and also auxiliary betting spots or side bet circles 55—adjacent to the sides of tables 54—for placing alternate side bets. Alternatively side bet areas 55 can be on top or bottom of tables 54. These betting spots may be marked with any shapes or symbols such as a square, rectangle or an x or a dot. In a preferred embodiment of the present invention, these auxiliary betting spots or side bet circles 55 complement the theme of the side bets. Other parts of the playing surface can also reflect the theme of the game, such as the logo 59 are inside arcuate portion 53 in FIG. 2. Although six player positions are shown in FIG. 2, more players or as few as one player and one dealer may play the game. As further shown in FIG. 3, the playing surface 50 can also have a discard rack 50, a cash shute 51, a rack 52, a dealer pay table 53, and a shoe 54.

In a further embodiment, a game as described herein can be played on an electronic device, such as an electronic gaming machine (EGM). The game can also be played over a computer communications network, such as the Internet, and can also be offered at online casinos.

FIG. 3 is an exemplary block diagram of hardware that can be used to implement an electronic embodiment. At least on processing unit 60, which executes code to implement operational steps of the game of the present invention, can be connected to at least one output unit 62 (e.g., LCD), at least one input unit 64 (e.g. a touch screen, keyboard, buttons, etc.), at least one network connection 66 (e.g. connection to a casino server or the Internet or other communication network), at least one memory device, such as ROM 68, and a RAM 70, and any other hardware known in the art needed to implemented a digital version of the game (not pictured). The game can also be served to a remote client playing at an online casino over a computer communications network (such as the internet), each of which interact with user(s) 72.

The game can be played with a single deck or multiple decks of the new and original card deck composition (e.g. 1-8 decks or more). Standard rules of Blackjack can be used as well as any known variation of Blackjack. Further, the order of any of the operations described herein can be performed in any order and wagers can be placed/resolved in any order. Any embodiments herein can also be played in electronic form and programs and/or data for such can be stored on any type of computer readable storage medium (e.g. CD-ROM, DVD, disk, etc.)

In view of the above, it will be seen that the several objects of the invention are achieved and other advantageous results attained. As various changes could be made in the above method of play without departing from the scope of the invention, it is intended that all matter contained in the above description or shown in the accompanying drawings shall be interpreted as illustrative and not in a limiting sense.

What is claimed is:

1. A method to play a Blackjack card game variation between a player and a dealer involving, the method comprising:
executing the following operations on an electronic processing unit:
a. initiating a Blackjack card game involving at least one player and including a deck of cards in which all Jack and Queen cards are removed and King cards in corresponding suits are substituted therefore, a game table with side bet areas, a designated coin for placing a side bet, and an optional side wager option bonus scheme based on three-of-a-kind and four-of-a-kind combinations resulting from comparison of a player's initial two dealt cards, the dealer's up card, and the dealer's down card;
b. receiving an initial mandatory wager from the at least one player;
c. allowing the at least one player to place an optional side wager based on the bonus scheme and using the designated coin;
d. determining whether the least one player placed an optional side wager based on the bonus scheme and using the designated coin;
e. proceeding with a regular Blackjack game if no optional side wagers have been placed;
f. if at least one side wager has been place, dealing the at least one player's initial two cards and the dealer's initial two cards before proceeding further with the Blackjack game;
g. comparing the at least one player's cards to the dealer's up card and determining whether all three cards match for a three-of-a-kind;
h. comparing the matched cards to the bonus scheme;
i. resolving any pay-out on any optional side wager;
j. proceeding with the regular Blackjack game;
k. turning over the dealer's down card;
l. comparing the at least one player's initial two cards and the dealer's up card to the dealer's down card and determining whether all four cards match for a four-of-a-kind;
m. comparing the matched cards including the dealer's down card to the bonus scheme; and
n. resolving any pay-out on any optional side wager.

2. The method as recited in claim 1, wherein the bonus scheme can provide pay-outs based on three-of-a-kind or four-of kind combinations selected from the group consisting of any combinations, combinations in the same color cards, combinations in the same suit of cards, and any combinations of the foregoing combinations.

3. The method as recited in claim 2, wherein the pay-out on the bonus scheme can be limited to a particular type of card or cards.

4. The method as recited in claim 3, wherein the bonus scheme can be associated with a particular theme for the game.

5. A Blackjack gaming system comprising
at least one input device;
at least one processor;
at least one display device; and
at least one memory device storing a plurality of instructions which, when executed by the at least one processor, cause the at least one processor to operate with the at least one display device and the at least one input device to, for a play of a Blackjack game;
a. initiate a Blackjack card game involving at least one player and including a deck of cards in which all Jack and Queen cards are removed and King cards in corresponding suits are substituted therefore, and an optional side wager option bonus scheme based on three-of-a-kind and four-of-a-kind combinations resulting from comparison of a player's initial two dealt cards, the dealer's up card, and the dealer's down card;
b. receive an initial mandatory wager from the at least one player;
c. allow the at least one player to place an optional side wager based on the bonus scheme and using a designated coin;
d. determine whether the least one player placed an optional side wager based on the bonus scheme and using the designated coin;
e. proceed with a regular Blackjack game if no optional side wagers have been placed;
f. if at least one side wager has been place, deal the at least one player's initial two cards and the dealer's initial two cards before proceeding further with the Blackjack game;
g. compare the at least one player's cards to the dealer's up card and determine whether all three cards match for a three-of-a-kind;
h. compare the matched cards to the bonus scheme;
i. resolve any pay-out on any optional side wager;
j. proceed with the regular Blackjack game;
k. turn over the dealer's down card;
l. compare the at least one player's initial two cards and the dealer's up card to the dealer's down card and determine whether all four cards match for a four-of-a-kind;
m. compare the matched cards including the dealer's down card to the bonus scheme; and
n. resolve any pay-out on any optional side wager.

6. The gaming system as recited in claim 5, wherein the bonus scheme can provide pay-outs based on three-of-a-kind and four-of-a-kind combinations selected from the group consisting of any combinations, combinations in the same color cards, combinations in the same suit of cards, and any combinations of the foregoing combinations.

7. The gaming system as recited in claim 6, wherein the pay-out on the bonus scheme can be limited to a particular type of card or cards.

8. The gaming system as recited in claim 7, wherein the bonus scheme can be associated with a particular theme for the game.

9. A method to play a Blackjack variation between a player and a dealer the method comprising:
a. initiating a Blackjack card game involving at least one player and including a deck of cards in which all Jack and Queen cards are removed and King cards in corresponding suits are substituted therefore, a game table with side bet areas, a designated coin for placing a side bet, and an optional side wager option bonus scheme based on three-of-a-kind and four-of-kind combinations resulting from comparison of a player's initial two dealt cards, the dealer's up card, and the dealer's down card;
b. receiving an initial mandatory wager from the at least one player;
c. allowing the at least one player to place an optional side wager based on the bonus scheme and using the designated coin;
d. determining whether the least one player placed an optional side wager based on the bonus scheme and designated coin;
e. proceeding with a regular Blackjack game if no optional side wagers have been placed;
f. if at least one side wager has been place, dealing the at least one player's initial two cards and the dealer's initial two cards before proceeding further with the Blackjack game;
g. comparing the at least one player's cards to the dealer's up card and determining whether all three cards match for a three-of-a-kind;
h. comparing the matched cards to the bonus scheme;
i. resolving any pay-out on any optional side wager;
j. proceeding with the regular Blackjack game;
k. turning over the dealer's down card;
l. comparing the at least one player's initial two cards and the dealer's up card to the dealer's down card and determining whether all four cards match for a four-of-a-kind;
m. comparing the matched cards including the dealer's down card to the bonus scheme; and
n. resolving any pay-out on any optional side wager.

10. The method as recited in claim 9, wherein, if the dealer's up card matches the player's two initial cards to form a three-of-a-kind match, and the three-of-a-kind matches the bonus scheme, the method includes the additional step of providing the player with the option of accepting a current pay-out on any optional side wager and foregoing any side wager pay-out based on the dealer's down card, or passing on a current pay-out and waiting on a potential side wager pay-out based on the dealer's down card.

11. The gaming system as recited in claim 9, wherein the bonus scheme can provide pay-outs based on three-of-a-kind and four-of-a-kind combinations selected from the group consisting of any combinations, combinations in the same color cards, combinations in the same suit of cards, and any combinations of the foregoing combinations.

12. The gaming system as recited in claim 11 wherein the pay-out on the bonus scheme can be limited to a particular type of card or cards.

13. The gaming system as recited in claim 12, wherein the bonus scheme can be associated with a particular theme for the game.

14. The gaming system as recited in claim 13, wherein the game board includes designations reflecting the theme of the game.

15. The gaming system as recited in claim 9, wherein the designated coin has preset values.

16. The gaming system as recited in claim 15, where in the present values are selected from the group consisting of $1, $5, $10, $20, $25, and $50.
